(19) United States
(12) Patent Application Publication
(10) Pub. No.: US 2008/0313665 A1
(43) Pub. Date: Dec. 18, 2008

(54) PRODUCT, METHOD AND SYSTEM FOR DYNAMICALLY TUNING A TELEVISION SET DURING ACTIVATION

(75) Inventors: Arthur R. Francis, Raleigh, NC (US); Veronique Le Shan Tice Moses, Raleigh, NC (US)

Correspondence Address: LEE LAW, PLLC;IBM CUSTOMER NUMBER, P.O. BOX 189, PITTSBORO, NC, 27312, US

(73) Assignee: INTERNATIONAL BUSINESS MACHINES CORPORATION, Armonk, NY (US)

(21) Appl. No.: 11/763,864

(22) Filed: Jun. 15, 2007

(51) Int. Cl. H04H 9/00

(52) U.S. Cl. 725/14

(57) ABSTRACT

The invention discloses a product, method and system for dynamically tuning the “default” television (TV) channel displayed during activation of a television set, which can be individually programmed by the viewer (i.e., the “default” or current choice) or automatically selected by determining the TV station(s) and/or program(s) that are most popular or important to that viewer (i.e., based on a collective viewing audience such as through use of social networking techniques).

### TECHNICAL FIELD

The invention relates to tuning a television set during activation.

### BACKGROUND

Using prior art television (TV) technology, the initial television station displayed when a viewer activates (or “turns on”) a TV set (i.e., the “default” TV channel) is automatically set to the one that was viewed immediately prior to the most recent deactivation (or “power-off”) of the set. However, with the advent of current digital television technology (including cable and satellite TV as well as on and off-line digital media players/recorders and internet TV broadcasting) a programming mechanism exists to modify the default station displayed upon activation (or at “power-on”) of a TV set, providing a viewer with the latitude to determine his or her favorite channel to display when the television is turned on. This option works well if a TV viewer always knows which channel he or she desires to view when turning the television on.

Many times a viewer may not be aware of programming content shown on other TV channels at the time that the set is activated, which may be more important to that viewer or deemed optimal for the viewer based on personal or overall TV viewership (and/or as determined by a social networking paradigm). For example, a viewer may turn on the TV set at a particular point in time (“X”) upon which the set defaults to either (a) the last TV station viewed at the most recent “power-off” or (b) the channel programmed by that viewer to be displayed at “power-on”. However, many TV programs may be available on alternate stations (with programming of interest or importance) that may be missed by a viewer who cannot initially change the last viewed (and/or programmed) “default” channel displayed on that television set when it is turned on.

### SUMMARY OF THE INVENTION

The invention provides a product, method and system for dynamically tuning the “default” television (TV) channel(s) displayed during initial “power-on” (or other) activation(s) of a television set, which can be individually programmed by the viewer or automatically selected by determining the TV station(s) and/or program(s) that are most popular or important to that viewer (including through use of a collective viewing audience as determined by social networking techniques) during the time period(s) in which the TV set is activated.

Alternately, the invention provides a dynamic alert/notification mechanism for special programming events (such as a “breaking news” story) to automatically display a TV channel carrying that event at the time of “power-on” (or at any other time while the TV is activated). This feature is optionally selectable by the viewer to augment the other “power-on” features, i.e., displaying the last station viewed at “power-off” or the “default” TV channel (either programmed by the viewer or automatically tuned as described herein).

It is therefore an object of the present invention to provide a product, method and system for dynamically tuning the “default” television (TV) channel(s) displayed during activation of a television set.

It is another object of the present invention to provide a dynamic notification mechanism for special programming events to automatically display a TV channel carrying that event.

The subject matter which is regarded as the invention is particularly pointed out and distinctly claimed in the concluding portion of the specification. The invention, however, together with further objects and advantages thereof, may best be understood by reference to the following description taken in conjunction with the accompanying drawings.

### BRIEF DESCRIPTION OF THE DETAILED DRAWINGS

FIG. 1 illustrates a diagram outlining operation of a dynamic TV channel tuning system according to the invention.

### DETAILED DESCRIPTION OF THE PREFERRED EMBODIMENTS

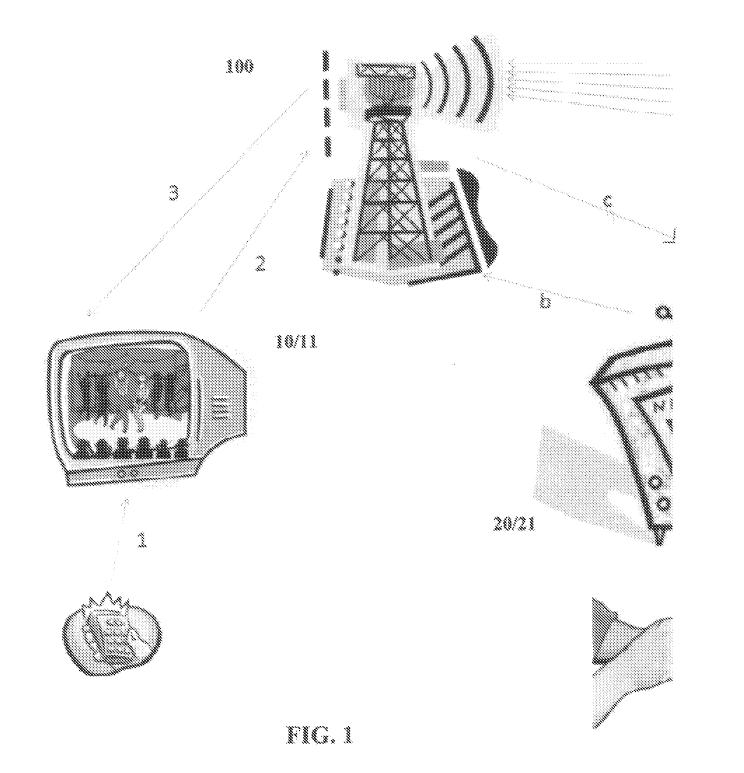

FIG. 1 illustrates a diagram outlining a dynamic TV channel tuning system in accordance with a preferred embodiment of the present invention, including a television (TV) set 10 and/or 20 containing an embedded computerized “metering agent” device 11 or 21 (respectively) that detects the period(s) and/or amount(s) of time during which the TV is set to display a particular station and/or program. A TV set can be manually or automatically programmed to display selected channel(s) 1 or a during “power-on” (or at other times) where it is activated to operate using a television antenna and/or via a cable or satellite programming system or over the internet. Preferably, the invention is used with a TV set that displays one channel at a time, but it may also be used with more advanced television technology that can simultaneously display multiple TV stations (and/or has other capabilities such as the “picture-within-a-picture” feature). In the case of multiple displays, each embedded display can be provided with the capability of being programmed with its own unique “power-on” TV channel.

Preferably, the recommendation for a “power-on” TV station and/or program 1 or a (to be displayed at any given point in time) is determined by a “metering” computer processor 100 that can be locally or remotely configured (using existing software programming techniques) to communicate with the “metering agent” 11 or 21 of any individual TV set 10 or 20 incorporated within the system. The “metering processor” can receive input on viewed programming content from “metering agents” (as described above) that can be individually used and/or collected and “aggregated” for distribution to other television sets included within the system (and/or broadcast network). The system can automatically select the “power-on” TV channel using existing “viewer metering” techniques (such as the Nielsen® TV ratings) or other television programming content sampling techniques (such as “real-time ambient audio identification” or the number of “BitTorrent downloads” requested by off-line TV media viewers or the network bandwidth utilized by internet TV viewers) to provide input for setting the “default” channel displayed upon television activation. This “metering information” can be leveraged by an analog or digital (antenna-based and/or cable/satellite or internet-operated) television to program the optimal and/or default “power-on” TV channel as customized for a specific viewer. In an alternate embodiment, a television set 10 or 20 can be provided with a mechanism that overrides a programmable TV channel 1 or a (at “power-on” or any other time) based on critical (or desired) programming content (such as for example breaking news or weather announcements, reported criminal activity or any other event requiring immediate notification).

In preferred operation, a TV viewer controls a remote control (or other) input programming device to activate (or “turn on”) a television set 10 or 20 incorporated within the system (or broadcast network) which transmits an indication of its presently-tuned channel 2 or b (such as the TV station being viewed immediately prior to the last time the set was “powered off”) to the central “metering” server 100 for processing to determine the “optimal” power-on channel 1 or a using internal computer program algorithms (implementing the techniques described herein). The “metering agent” device 11 or 21 embedded in the TV set then obtains an identification of the optimal/default “power on” channel(s) 1 or a for the time period(s) in which the TV is activated (as distributed on demand or in “real-time” from the “metering server” 3 or c) so that the TV is automatically tuned to those “power-on” channel(s) when the viewer activates the set. If multiple displays are supported, then each of the “power-on” TV channels for the additional displays are obtained from the centralized server (as described herein) for display until the viewer desires to move to an alternate channel.

While certain preferred features of the invention have been shown by way of illustration, many modifications and changes can be made that fall within the true spirit of the invention as embodied in the following claims, which are to be interpreted as broadly as the law permits to cover the full scope of the invention, including all equivalents thereto.

What is claimed is:

1. A system for displaying one or more television signals and comprised of at least the following components configured for tuning a signal to display a television channel carrying a selected program during activation of a television set:
(a). at least one television set configured for manual or automatic operation to display one or more selected channels during activation;
(b). at least one metering agent each configured for detecting one or more periods or amounts of time during which a television set is tuned to a selected channel or program; and
(c). a metering processor locally or remotely configured to communicate with a metering agent of a television set for automatically selecting a displayed channel or program;
wherein a television channel selected for display is individually chosen by a viewer or automatically selected by determining a television program important to the viewer or to a collective viewing audience during one or more time periods in which a television set is activated.

2. The system of claim 1 wherein:
(a). a viewer controls an input device to activate a television set;
(b). a metering agent transmits an identification of the signal(s) presently tuned by the television set to the metering processor for determining one or more channels selected for display; and
(c). the metering agent obtains an identification of the selected channel(s) from the metering processor for automatically tuning one or more of the selected channels when the television set is activated.

3. The system of claim 1 wherein the metering processor receives input on viewed programming content from one or more metering agents that is individually used or collected and aggregated for distribution to other television sets in the system.

4. The system of claim 3 wherein a television channel is selected for display using Nielsen® TV ratings or real-time ambient audio identification or BitTorrent downloads or internet television network bandwidth programming content sampling techniques.

5. The system of claim 1 wherein notification of a special programming event is automatically displayed by a channel carrying that event while the television set is activated.

6. The system of claim 1 wherein a television set simultaneously displays multiple selected channels.

7. A method of using a system for displaying one or more television signals and comprised of at least the following components configured for carrying out at least the following steps to tune a signal to display a television channel carrying a selected program during activation of a television set:
(a). configuring at least one television set for manual or automatic operation to display one or more selected channels during activation;
(b). configuring at least one metering agent each for detecting one or more periods or amounts of time during which a television set is tuned to a selected channel or program; and
(c). locally or remotely configuring a metering processor to communicate with a metering agent of a television set for automatically
selecting a displayed channel or program;
wherein a television channel selected for display is individually chosen by a viewer or automatically selected by determining a television program important to the viewer or to a collective viewing audience during one or more time periods in which a television set is activated.

8. The method of claim 7 wherein:
(a). a viewer controls an input device to activate a television set;
(b). a metering agent transmits an identification of the signal(s) presently tuned by the television set to the metering processor for determining one or more channels selected for display; and
(c). the metering agent obtains an identification of the selected channel(s) from the metering processor for automatically tuning one or more of the selected channels when the television set is activated.

9. The method of claim 7 wherein the metering processor receives input on viewed programming content from one or more metering agents that is individually used or collected and aggregated for distribution to other television sets in the system.

10. The method of claim 9 wherein a television channel is selected for display using Nielsen® TV ratings or real-time ambient audio identification or BitTorrent downloads or internet television network bandwidth programming content sampling techniques.

11. The method of claim 7 wherein notification of a special programming event is automatically displayed by a channel carrying that event while the television set is activated.

12. The method of claim 7 wherein a television set simultaneously displays multiple selected channels.

13. A product used with a system for displaying one or more television signals comprised of at least the following components configured for tuning a signal to display a television channel carrying a selected program during activation of a television set:
(a). at least one television set configured for manual or automatic operation to display one or more selected channels during activation;
(b). at least one metering agent each configured for detecting one or more periods or amounts of time during which a television set is tuned to a selected channel or program; and
(c). a metering processor locally or remotely configured to communicate with a metering agent of a television set for automatically selecting a displayed channel or program;
wherein a television channel selected for display is individually chosen by a viewer or automatically selected by determining a television program important to the viewer or to a collective viewing audience during one or more time periods in which a television set is activated.

14. The product of claim 13 wherein:
(a). a viewer controls an input device to activate a television set;
(b). a metering agent transmits an identification of the signal(s) presently tuned by the television set to the metering processor for determining one or more channels selected for display; and
(c). the metering agent obtains an identification of the selected channel(s) from the metering processor for automatically tuning one or more of the selected channels when the television set is activated.

15. The product of claim 13 wherein the metering processor receives input on viewed programming content from one or more metering agents that is individually used or collected and aggregated for distribution to other television sets in the system.

16. The product of claim 15 wherein a television channel is selected for display using Nielsen® TV ratings or real-time ambient audio identification or BitTorrent downloads or internet television network bandwidth programming content sampling techniques.

17. The product of claim 13 wherein notification of a special programming event is automatically displayed by a channel carrying that event while the television set is activated.

18. The product of claim 13 wherein a television set simultaneously displays multiple selected channels.
